(19) United States
(12) Patent Application Publication
(10) Pub. No.: US 2025/0171973 A1
(43) Pub. Date: May 29, 2025

(54) Shoreline structure and construction method for minimizing wind and wave impacts while incorporating ecological landscaping

(71) Applicant: Shanghai Investigation, Design & Research Institute Co., Ltd., Shanghai (CN)

(72) Inventors: Hao ZHANG, Shanghai (CN); Dongzhou ZHU, Shanghai (CN); Yongqing WANG, Shanghai (CN); Yali YANG, Shanghai (CN); Jiale FAN, Shanghai (CN); Yinghua ZHAO, Shanghai (CN); Zhichao WANG, Shanghai (CN); Zhimin LI, Shanghai (CN); Xuxu WANG, Shanghai (CN); Wei AI, Shanghai (CN); Yuanshun LI, Shanghai (CN); Junxiu ZHANG, Shanghai (CN); Zhifeng YE, Shanghai (CN)

(73) Assignee: Shanghai Investigation, Design & Research Institute Co., Ltd., Shanghai (CN)

(21) Appl. No.: 18/623,076

(22) Filed: Apr. 1, 2024

(30) Foreign Application Priority Data
Nov. 23, 2023 (CN) 2023115708445

(51) Int. Cl. E02B 3/06; E02B 3/12

(52) U.S. Cl. CPC E02B 3/06; E02B 3/12

(57) ABSTRACT

The present invention discloses a shoreline structure and a construction method thereof, the structure includes a wave-absorbing submerged breakwater, a soil embankment, a shallow beach area, a deep-water ditch, and planting platforms. The wave-absorbing submerged breakwater includes a first gabion box and a first emergent plant on the top; the shallow beach area includes a third emergent plant; the deep-water ditch is located between the shallow beach area and the wave-absorbing submerged breakwater, and includes a submerged plant; planting platforms are dispersed within the deep-water ditch, and have a second emergent plant. The present invention dissipates the wind and waves on the shoreline slope through the wave-absorbing submerged breakwater, and the planting platforms are dotted in the deep-water ditch, creating wetland habitats alternating between deep and shallow water, and a near-shore waterfront wetland environment to purify and maintain the water quality of the lakes and reservoirs.

### TECHNICAL FIELD

The present invention relates to the technical field of ecological restoration of shoreline zones, especially relates to a shoreline structure and construction method for minimizing wind and wave impacts while incorporating ecological landscaping.

### BACKGROUND TECHNOLOGY

Shoreline are very important ecological transition zones between river or lake ecosystems and terrestrial ecosystems, where submerged plants, floating-leaf plants, water-supporting plants, wet plants, and terrestrial plants sequentially grow from water to land. So shoreline area is a key habitat for organisms such as fish, amphibians, birds and insects. The unique geographic location of a shoreline makes it an important place for material exchange, energy transfer, and information exchange between land and water, and it has a variety of ecological functions such as maintaining the stability of the riverbanks, intercepting pollutants, protecting water source quality of rivers, protecting species diversity and landscape functions, which are of great significance for maintaining the ecological balance and improving the natural conditions.

Lakes and reservoirs have wide open water surfaces and large wind ranges. Strong impacts from wind and aquatic wave formation are very likely to adversely affect water quality, plants, and shoreline erosion, which can cause serious consequences. For example, when the reservoir water level is low, the wind and aquatic wave action will stir up the shallow bottom mud and other sediments, making water turbid, reducing its clarity and deteriorating the water source environment. At the same time, affected by the wind and wave churning impact, aquatic plants used to purify water quality become cut off, small aquatic animals can die of repeated beatings. The remains of these aquatic animals and aquatic plants decompose by prolonged immersion in water, increasing nitrogen and phosphorus contents in the water which leads to eutrophication, significantly accelerating and exacerbating deterioration of the water environment and degrading the water quality. In addition, the waterfront slope of the embankment is subjected to repeated impacts and beatings by the wind and waves, so the soil embankment of the shoreline slope is scrubbed, the shoreline then is prone to producing holes and can even collapse, severely affecting the area safety.

The impact of wind and waves on the lake and reservoir slopes thereby the water environment safety is directly affecting later operation and maintenance of water sources and landscape. As people's living standards improve, the demand for good ecological landscape and water source qualities has also increased. In the future, the wind and wave protection measures for lake and reservoir water sources will not only consider engineering safety, but also cover landscape, water quality maintenance, protection of aquatic plants and animals, biodiversity, and other comprehensive needs.

The wind and wave reduction at the shoreline is one of the important means to maintain the ecological environment thereof, which not only ensures the stability of the bank slopes but also purifies the water, thus maintaining and improving the water quality in the lakes and reservoirs. However, the existing wind and wave protection facilities are mainly aimed at maintaining the stability of bank slopes and are mostly hard structures which only narrow the bank ranges, and do not have the capability to create miniature wetlands to purify water along the banks, so they have little effects on water purification and maintenance of coastal habitats.

Therefore, it becomes a technical problem to be solved, in order to minimize wind and wave impacts on the shoreline while incorporating ecological landscaping.

### SUMMARY OF THE INVENTION

The present disclosure provides a shoreline structure for minimizing wind and wave impacts while incorporating ecological landscaping, in order to address the technical challenge of balancing wind and wave prevention with the preservation of ecological landscapes in the existing shoreline structure.

The present disclosure provides a shoreline structure that combines wind and wave prevention with ecological landscaping. The shoreline structure includes:
a wave-absorbing submerged breakwater, which is provided with a first gabion box and first emergent plants on the top, the first gabion box is located on the waterward side of the first emergent plants and has a top elevation above the standing water level;
a slope protection, which is permanently located on the waterward side of the wave-absorbing submerged breakwater;
a shallow beach area, which is provided on the backwater side of the wave-absorbing submerged breakwater and is provided with the third emergent plants;
a deep-water ditch, which is provided between the shallow beach area and the wave-absorbing submerged breakwater and is provided with submerged plants;
a plurality of planting platforms scattered within the deep-water ditch and the planting platforms are provided with the second emergent plants.

Preferably, the wave-absorbing submerged breakwater includes a soil embankment, a first gabion box, and a second gabion box. The first gabion box is permanently located on the waterward side of the soil embankment, while the second gabion box is permanently located on the backwater side of the soil embankment. The first gabion box and the second gabion box are permanently connected in parallel and form a planting grid, and the first emergent plants are planted in the planting grid.

Preferably, the top elevation of the first gabion box is about 20 cm above the standing water level and the top elevation of the second gabion box is equal to the standing water level.

Preferably, the slope protection includes a gabion mat and a third gabion box. The gabion mat is permanently laid on the slope of the soil embankment. The top end of the gabion mat is permanently connected to the first gabion box, and the bottom end of the gabion mat is permanently connected to the third gabion box. The top elevation of the third gabion box is set to at least half a mean wave height below the low water level.

Preferably, the planting platform includes planting stakes and planting soil. The bottom end of the planting stake is embedded in the deep-water ditch, and a plurality of the planting stakes are connected in turn to form a planting cavity. The planting soil is filled in the planting cavity, and the second emergent plants are planted in the planting soil.

Preferably, the shallow water beach area has a water depth of about 20 cm and the deep-water ditch has a water depth of about 1000 cm.

Preferably, the shoreline structure has a width of 30 m to 100 m.

The present disclosure further provides a construction method for minimizing wind and wave beating impacts while incorporating ecological landscaping, including the following steps:
delineating the extent of the shoreline along the water source perimeter according to the landscape demand and the topographic conditions of the water flow, constructing a wave-absorbing submerged breakwater around the shoreline range, and then laying out slope protection for protection on the waterward slope of the wave-absorbing submerged breakwater;
excavating a deep-water ditch with a trapezoidal cross-section on the backwater side of the wave-absorbing submerged breakwater based on landscape flow regime requirements;
driving planting stakes and filling with about 50 cm of planting soil in the deep-water ditch to form a planting platform according to the landscape shape and flow regime requirements;
planting of first emergent plants on the top of the wave-absorbing submerged breakwater, second emergent plants on the planting platform, third water-supporting plants on the shallow beach area, and submerged plants in the deep-water ditch.

The present invention has the following beneficial effects:
the present invention is provided with a wave-absorbing submerged breakwater on the side of the shoreline close to the lake area, and first emergent plants are planted on the wave-absorbing submerged breakwater. A deep-water ditch for planting submersed plants and a shallow beach area for planting third emergent plants are provided on the backwater side of the wave-absorbing submerged breakwater, and a plurality of planting platforms for planting second emergent plants are scattered within the deep-water ditch, so that a shoreline of lakes and reservoirs is constructed between the wave-absorbing submerged breakwater and land area, thereby forming a nearshore micro-wetland and creating a diverse ecological landscape. The present invention has a first gabion box on the top of the wave-absorbing submerged breakwater, and a slope protection permanently located on the waterward side of the wave-absorbing submerged breakwater, the water can flow between the shoreline and the lake area through the first gabion box, playing the role of abatement of lakes and reservoirs wind and waves to protect the shoreline, not only to ensure the stability of the shore protection but also to purify and maintain the water quality of lakes and reservoirs.

### DESCRIPTION OF DRAWINGS

FIG. 1 shows a schematic plan view of a shoreline structure integrating wind-wave protection and ecological landscaping according to the present disclosure; and

FIG. 2 shows an A-A view of FIG. 1.

### REFERENCE SIGNS

10 Wave-absorbing submerged breakwater
11 Soil embankment
12 First gabion box
13 Second gabion box
14 First emergent plant
20 Slope protection
21 Gabion mat
22 Third gabion box
30 Shallow beach area
31 Third emergent plant
40 Deep-water ditch
41 Submerged plant
50 Planting platform
52 Planting soil
53 Second emergent plant

### DETAILED DESCRIPTION

The specific embodiments of the present invention will be further described in conjunction with the accompanying drawings. These embodiments are only used to illustrate the present invention and are not intended to limit the present invention.

In the description of the present invention, it should be noted that the terms “center,” “longitudinal,” “lateral,” “upper,” “lower,” “front,” “rear,” “left,” “right,” “vertical,” “horizontal,” “top,” “bottom,” “inner,” “outer,” and the like, indicating the orientation or positional relationship are based on the orientation or positional relationship shown in the accompanying drawings, solely for the purpose of facilitating the description of the present invention and simplifying the description, rather than indicating or implying that the device or component referred to must have a specific orientation, be constructed and operated in a specific orientation, and therefore should not be understood as limiting the present invention. In addition, the terms “first” and “second” are only used for descriptive purposes and should not be understood as indicating or implying relative importance.

In this invention, unless otherwise specified and limited, terms such as “installation”, “connection”, “fixing”, “fastening” should be broadly understood, for example, it can be a fixed connection, a detachable connection, or a monolithic connection; it can be a mechanical connection, or an electrical connection; it can be a direct connection, or an indirect connection through an intermediate medium, and it also can be an internal connection between two components. For those skilled in art, the specific meanings of the above terms in this invention can be understood according to the specific situation.

Additionally, in the description of the present disclosure, “plural” means two or more unless otherwise specified.

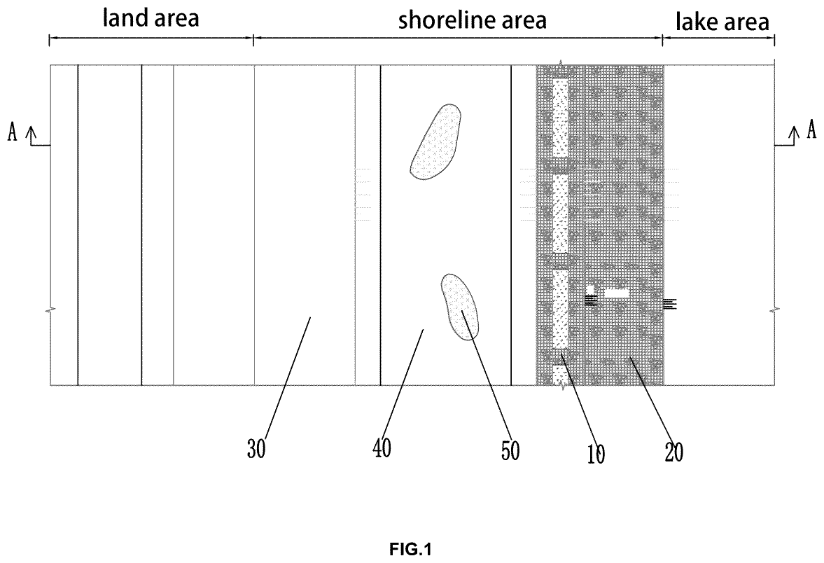

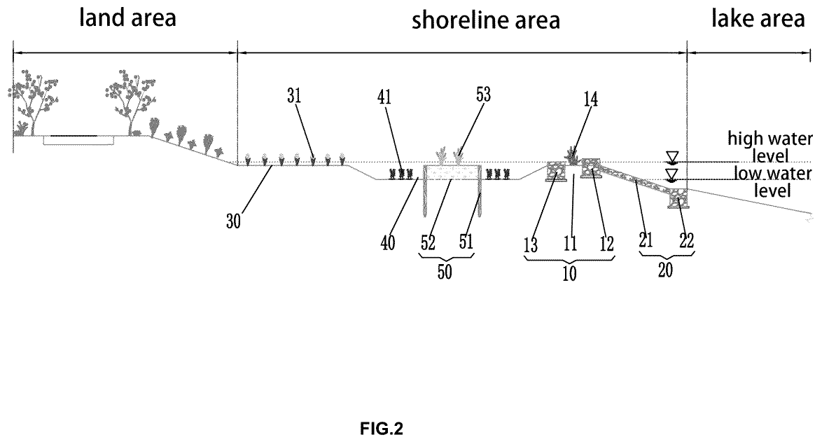

As shown in FIGS. 1 and 2, a shoreline structure integrating wind-wave protection and ecological landscaping, which includes:
a wave-absorbing submerged breakwater 10, which is provided with a first gabion box 12 and first emergent plants 14 on the top. The first gabion box 12 is located on the waterward side of the first emergent plants 14, and the top elevation of the first gabion box 12 is higher than the standing water level of the lake.
a soil embankment 20, which is permanently disposed on the waterward side of the wave-absorbing submerged breakwater 10, and is used to ensure bank slope stability.
a shallow beach area 30, which is provided on the backwater side of the wave-absorbing submerged breakwater 10 and proximate to a side of the land area, and the shallow beach area 30 is provided with third emergent plants 31.
a deep-water ditch 40, which is provided between the shallow water beach area 30 and the wave-absorbing submerged breakwater 10, and the deep-water ditch 40 is provided with submerged plants 41.
a plurality of planting platforms 50 are dispersed within the deep-water ditch 40, and the planting platforms 50 are provided with second emergent plants 53.

The present invention is provided with a wave-absorbing submerged breakwater 10 on the side of the shoreline close to the lake area, and first emergent plants 14 are planted on the wave-absorbing submerged breakwater 10. A deep-water ditch 40 for planting submersed plants 41 and a shallow beach area 30 for planting third emergent plants 31 are provided on the backwater side of the wave-absorbing submerged breakwater 10, and a plurality of planting platforms 50 for planting second emergent plants 53 are scattered within the deep-water ditch 41, so that shoreline of lakes and reservoirs is constructed between the wave-absorbing submerged breakwater 10 and land area, thereby forming a nearshore micro-wetland and creating a diverse ecological landscape. The present invention has a first gabion box 12 on the top of the wave-absorbing submerged breakwater 10, and a slope protection 20 permanently located on the waterward side of the wave-absorbing submerged breakwater 10, the water can flow between the shoreline and the lake area through the first gabion box 12, playing the role of abatement of lakes and reservoirs wind and waves to protect the shoreline, not only to ensure the stability of the shore protection but also to purify and maintain the water quality of lakes and reservoirs.

In one embodiment, as shown in FIGS. 1 and 2, the wave-absorbing submerged breakwater 10 includes a soil embankment 11, a first gabion box 12 and a second gabion box 13, where the wave-absorbing submerged breakwater 10 has the first gabion box 12 and the second gabion box 13 arranged in a one-to-one through-length arrangement on both sides of the top of the breakwater, the first gabion box 12 is permanently disposed on the waterward side of the soil embankment 11 (close to the side of the lake area), the second gabion box 13 is permanently disposed on the backwater side of the soil embankment 11, and the first gabion box 12 and the second gabion box 13 are disposed in parallel with each other at an interval of 5 m. The first gabion box 12 and the second gabion box 13 are permanently connected to each other to form a planting grid, and the first emergent plants 14 of different species are planted in different zones in the planting grid.

Preferably, the top elevation of the first gabion box 12 is about 20 cm above the lake's standing water level, and the top elevation of the second gabion box 13 is equal to the lake standing water level.

It is set up as described above because: the first gabion box 12 and the second gabion box 13 not only maximize wave dissipation but also connect the water system inside and outside the wave-absorbing submerged breakwater 10, which in turn purifies and maintains the water quality of the lake and reservoir through the aquatic plants in the shoreline.

More preferably, the slope protection 20 includes a gabion mat 21 and a third gabion box 22. The gabion mesh mat 21 is permanently laid on the slope of the soil embankment 11. The top end of the gabion mat 21 is permanently connected to the first gabion box 12, and the bottom end of the gabion mat 21 is permanently connected to the third gabion box 22, that is to say, the slope of the waterward side of the soil embankment 11 is protected by the gabion mat 21, with protection extending from the top of the embankment to below the low water level of the lake. A third gabion box 22 is used as a footing at the lowest point of the gabion mat 21 to prevent the gabion mat 21 from sliding downslope, and the top elevation of the third gabion box 22 is at least one-half of the mean wave height below the low water level in the lake area.

In one embodiment, as shown in FIGS. 1 and 2, the planting platform 50 includes planting stakes 51 and planting soil 52. The bottom end of the planting stakes 51 is embedded in the deep-water ditch 40, and a plurality of the planting stakes 51 are connected in turn to form a planting cavity. The planting soil 52 is filled in the planting cavity, that is to say, the planting platform 50 is shaped by filling the planting soil 52 within the circle shape by means of the planting stakes 51, and the water depth on the planting platform 50 is about 20 cm, and the second emergent plant 53 is planted in the planting soil 52.

In one embodiment, as shown in FIGS. 1 and 2, the shallow water beach area 30 has a water depth of about 20 cm and is planted with third emergent plants 31; the deep-water ditch 40 has a water depth of about 1,000 cm and is planted with submerged plants 41, and the bottom elevation of the deep-water ditch 40 is equal to the low water level of the lake area.

Preferably, the width of the shoreline structure is 30 m to 100 m.

As shown in FIGS. 1 and 2, a construction method for minimizing wind and wave impacts while incorporating ecological landscaping, including the following steps:
Step 1: delineating the extent of the shoreline along the water source perimeter according to the landscape demand and the topographic conditions of the water flow, constructing a soil embankment 11 of a wave-absorbing submerged breakwater 10 around the shoreline range, and then laying out a first gabion box 12 and a second gabion box 13 on the embankment top of the soil embankment 11, as well as a gabion mat 21 and a third gabion box 22 on the slope of the soil embankment 11 for protection;
Step 2: excavating a deep-water ditch 40 with a trapezoidal cross-section on the backwater side of the wave-absorbing submerged breakwater 10 based on landscape flow regime requirements, and placing a footing gabion at the foot of the slope;
Step 3: driving planting stakes 51 and filling with about 50 cm of planting soil 52 in the deep-water ditch 40 to form multiple dispersed planting platforms 50 according to the landscape shape and flow regime requirements;
Step 4: planting of first emergent plants 14 on the top of the wave-absorbing submerged breakwater 10, second emergent plants 53 on the planting platform 50, third water-supporting plants 31 on the shallow beach area 30, and a submerged plant 41 in the deep-water ditch 40.

Where the first emergent plant 14 will cover the wave-absorbing submerged breakwater 10 and form a better ecological landscape when it grows up while improving overall wind and wave resistance and protecting aquatic plants in the nearshore wetlands of the backside shoreline. The second emergent plants 53, the third emergent plants 31, and the submersed plants 41 serve the function of water purification and maintenance.

Most of the wind and waves have been reduced under the action of the wave-absorbing submerged breakwater 10, which provides time and space for the growth of emergent plants and submerged plants in the shoreline, and when the aquatic plants have grown up, the aquatic plants can cover the wave-absorbing submerged breakwater 10, which is better in terms of landscape and ecology, and at the same time, the aquatic plants can reduce the remaining portion of wind and waves, so as to achieve the purpose of completely protecting the embankment; moreover, due to the existence of wave-absorbing submerged breakwater 10, the source water can maintain a certain water depth when the water level is lowered, which will not affect the growth of aquatic plants.

The shoreline structure of the present disclosure works as follows:

The shoreline structure of the present disclosure includes a wave-absorbing submerged breakwater, planting platforms, a deep-water ditch and a shallow water beach area. The width of the shoreline is 30 m-100 m; the wave-absorbing submerged breakwater is arranged in the outer circle of the lake area, which is able to dissipate most of the wind and waves thereof, and the planting platforms are dotted in the deep-water ditch, which is able to create wetland habitats alternating between deep and shallow water and to further dissipate the wind and waves so that it can not only reduce wind and waves but also create a near-shore waterfront wetland environment to purify and maintain the water quality of the lakes and reservoirs.

Compared to the existing facilities, the present invention has at least the following beneficial technical effects:
(1) The wave-absorbing submerged breakwater blocks the propagation path of wind and wave, reducing the wave height and the force of wind and wave, eliminating the repeated scouring effect of wind and waves on the embankment slopes, and ensuring that the slopes are protected from wind and wave hazards.
(2) The top of the wave-absorbing submerged breakwater is protected by a frame-type masonry, with interspersed planting of emergent plants, which further reduces wind and waves and covers the hard revetment, thus enhancing the landscape effect.
(3) The construction of the shoreline creates stable and diversified ecological environment conditions. The staggered arrangement of planting platforms, shallow water beach area and deep-water ditches in the shoreline creates diversified ecological environment conditions; the alternating changes of deep and shallow water provide conditions for the growth of various types of aquatic plants, and the created micro-wetland can repair and strengthen the self-purification ability of water and store water.

Through the construction of a miniature wetland in the shoreline and measures for wave elimination, the present disclosure can abate the impact of wave shock on the shoreline slope and protect the lake and reservoir form, and the suitable width of the shoreline ranges from 30 m to 100 m, which makes the shoreline largely unaffected by wind and waves.

The preferred embodiments of the present disclosure are discussed above but is not used to limit the present disclosure. The person skilled in the art can make various amendments or modification to the present disclosure. Any modification, equivalent replacement, improvement, etc. made within the spirit and principle of the present disclosure shall be within the protection scope of the present disclosure.

1. A shoreline structure, wherein the shoreline structure integrates wind-wave protection and ecological landscaping, the shoreline structure comprises:
a wave-absorbing submerged breakwater (10), comprising a first gabion box (12) and first emergent plants (14) on a top of the first gabion box (12), wherein the first gabion box (12) is located on a waterward side of the first emergent plants (14), and wherein a top elevation of the first gabion box (12) is higher than a standing water level;
a slope protection (20), which is permanently located on the waterward side of the wave-absorbing submerged breakwater (10);
a shallow beach area (30), located on a backwater side of the wave-absorbing submerged breakwater (10) and comprising third emergent plants (31);
a deep-water ditch (40), located between the shallow water beach area (30) and the wave-absorbing submerged breakwater (10), wherein the deep-water ditch (40) comprises submerged plants (41); and
a plurality of planting platforms (50) scattered within the deep-water ditch (40), wherein the plurality of planting platforms comprises second emergent plants (53).

2. The shoreline structure according to claim 1, wherein the wave-absorbing submerged breakwater (10) comprises a soil embankment (11), a second gabion box (13), wherein the first gabion box (12) is permanently located on the waterward side of the soil embankment (11), and the second gabion box (13) is permanently located on the backwater side of the soil embankment (11), wherein the first gabion box (12) and the second gabion box (13) are permanently connected in parallel and form a planting grid, and wherein the first emergent plants (14) are planted in the planting grid.

3. The shoreline structure according to claim 2, wherein the top elevation of the first gabion box (12) is about 20 cm above the standing water level, and the top elevation of the second gabion box (13) is equal to the standing water level.

4. The shoreline structure according to claim 2, wherein the slope protection (20) comprises a gabion mat (21) and a third gabion box (22), wherein the gabion mat (21) is permanently laid on the slope of the soil embankment (11), wherein a top end of the gabion mat (21) is permanently connected to the first gabion box (12), and a bottom end of the gabion mat (21) is permanently connected to the third gabion box (22), wherein a top elevation of the third gabion box (22) is at least half a mean wave height below a low water level.

5. The shoreline structure according to claim 1, wherein the planting platforms (50) comprise a plurality of planting stakes (51) and planting soil (52), wherein bottom ends of the plurality of the planting stakes (51) are embedded in the deep-water ditch (40), and the plurality of the planting stakes (51) is connected in turn to form a planting cavity, wherein the planting soil (52) fills in the planting cavity, and wherein the second emergent plants (53) are planted in the planting soil.

6. The shoreline structure according to claim 1, wherein the shallow water beach area (30) has a water depth of about 20 cm and the deep-water ditch (40) has a water depth of about 1000 cm.

7. The shoreline structure according to claim 1, wherein the shoreline structure has a width of 30 m to 100 m.

8. A construction method for minimizing wind and wave impacts on a shoreline while incorporating an ecological landscaping, wherein the method comprises following steps:
delineating an extent of the shoreline along a water source perimeter according to the ecological landscape's requirement and topographic conditions of a water flow along a shoreline range, constructing a wave-absorbing submerged breakwater (10) around the shoreline range, then laying out a slope protection (20) for protecting a waterward slope of the wave-absorbing submerged breakwater (10);
excavating a deep-water ditch (40) which has a trapezoidal vertical cross-section on a backwater side of the wave-absorbing submerged breakwater (10) based on ecological landscape requirement in flow;
setting planting stakes (51) into the deep-water ditch (40) and filling with about 50 cm depth planting soil (52) into the deep-water ditch (40) to form planting platforms (50) according to a shape of the ecological landscape and flow requirements; and
planting first emergent plants (14) on a top of the wave-absorbing submerged breakwater (10), planting second emergent plants (53) on the planting platform (50), planting third water-supporting plants (31) on a shallow beach area (30), and planting submerged plants (41) in the deep-water ditch (40), wherein the shallow beach area (30) is located on the backwater side of the wave-absorbing submerged breakwater (10).
